(19) United States
(12) Patent Application Publication
(10) Pub. No.: US 2025/0124463 A1
(43) Pub. Date: Apr. 17, 2025

(54) SYSTEM FOR EVALUATING STREAMING SERVICES AND CONTENT

(71) Applicant: c/o SmartScience Technologies, LLC., Austin, TX (US)

(72) Inventors: Duane Varan, Austin, TX (US); Erik Marc Johnson, Austin, TX (US); Patrick James Dalberg, Winston Salem, NC (US)

(21) Appl. No.: 18/485,432

(22) Filed: Oct. 12, 2023

(51) Int. Cl. G06Q 30/0203; G06N 20/00; H04N 21/431; H04N 21/45

(52) U.S. Cl. CPC G06Q 30/0203; G06N 20/00; H04N 21/431; H04N 21/4508

(57) ABSTRACT

A platform configured to provide a simulated content consuming environment or application accessible to one or more test users in order to determine one or more metrics associated with the user interface and/or overall experience of the streaming service and/or content that may be provided by the streaming service.

### BACKGROUND

Today, many industries, companies, and individuals rely upon physical focus group facilities including a test room and adjacent observation room to perform product and/or market testing. These facilities typically separate the two rooms by a wall having a one-way mirror to allow individuals within the observation room to watch proceedings within the test room. Unfortunately, in person testing is not always a suitable location for evaluating products and services. In some cases, such as streaming or direct delivery content, it may be more appropriate for a user to test and/or evaluate the service and/or content in a location similar to which the user routinely engages the service.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example pictorial view of a user participating in a simulation to evaluate a streaming service and/or streaming service content according to some implementations.

FIG. 2 illustrates an example flow diagram showing an illustrative process for providing a platform for evaluating streaming services and/or streaming service content according to some implementations.

FIG. 3 illustrates another example flow diagram showing an illustrative process for providing a platform for evaluating streaming services and/or streaming service content according to some implementations.

FIG. 4 illustrates another example flow diagram showing an illustrative process for providing a platform for evaluating streaming services and/or streaming service content according to some implementations.

FIG. 5 illustrates an example flow diagram showing an illustrative process for a third party client to access a platform for evaluating streaming services and/or streaming service content according to some implementations.

FIG. 6 illustrates an example platform according to some implementations.

### DETAILED DESCRIPTION

Described herein are devices and techniques for a virtual focus group facility via a cloud-based platform. The platform, discussed herein, replicates and enhances conventional focus group type data collection via a controlled environment, such as a one-way mirror experience, particularly with respect to streaming services, direct content delivery services, and/or content (e.g., movies, shows, videos, clips, commercials, advertisements, product placements, and the like). For example, the platform may be configured to simulate a user experience, user interface (e.g., user controls, graphical layouts, graphical styles, and the like), service performance (e.g., speed, quality, or other metrics), and the like associated with a streaming service in order to receive user feedback, engagement metrics, and/or other evaluation metrics of the streaming service for a third-party responsible for providing the streaming service and/or a competitor third-party.

The platform may also be utilized to receive user feedback, engagement metrics, and/or evaluation metrics associated with content (e.g., movies, shows, videos, clips, commercials, advertisements, product placements, and the like) placed or provided via the streaming service for the third party responsible for providing the stream service the third party responsible for providing the content (e.g., to evaluate different streaming services for content placement), and/or competitors of the streaming service and/or content providers. For example, the platform may be used to assist in determining user reception of content across various different streaming services, commercial or advertisement effectiveness, engagement, or reception across various different streaming services and/or different content items (e.g., different genres, categories, titles, episodes or seasons of a signal title, and the like). In some cases, the platform may also be utilized to receive user feedback, engagement metrics, and/or evaluation metrics associated with advertisements or commercials that are to be placed with respect to different content or streaming services for the third party responsible for providing the stream service, the third party responsible for providing the content being paired with the advertisement or commercial, and/or the third-party providing the advertisement or commercial, and/or competitors of the streaming service, content providers, and/or advertisement providers.

In some examples, the platform may generate metrics based on multiple evaluations of received user interaction data, feedback data, and/or sensor data. For example, the platform may provide the user interaction data, feedback data, and/or sensor data to one or more reviewers or platform operators that may review the user interaction data, feedback data, and/or sensor data and generate initial metrics. The initial metrics may then be processed via statistical analysis techniques (e.g., averaged, weighted, or the like) to generate metrics associated with the user's reaction, responses, emotions, or the like of the content data. In some cases, the platform may utilize multiple machine learned models or programs to evaluate the user interaction data, feedback data, and/or sensor data and generate the initial metrics in lieu of or in addition to operator metrics. In some examples, the platform may include an interface simulation system that is configured to replicate the user interface, performance, and/or interactions with one or more streaming services for the test user(s). For instance, a user may access the platform via a user device (e.g., a television, computer, mobile device, smart phone, tablet, or the like). The platform may then either allow the user to select or cause the user to select one or more streaming service simulation applications that provided at least a limited portion of the streaming service interface and any desired content (e.g., content provided by the streaming service, content provided by a content provider, content provided by an advertisement provider, or other third party). The content may or may not be otherwise currently available via the streaming service system.

As the user engages with the simulation of the streaming service, the platform captures data associated with the simulated session (e.g., the period of time the user is engaged with the simulation). In some examples, the platform may capture image data of the user via one or more cameras or image devices associated with the user device, audio data associated with the user via one or more microphones associated with the user device, and/or other physiological data via various biometric sensors either coupled to the user device or incorporated into the user device. In some examples, the user may utilize additional data capture systems, such as a physiological monitoring system worn by the user, such as on the head, hands, fingers, or the like of the user.

In an example, physiological data of the user may be captured by the physiological monitoring system. Physiological data may include blood pressure, heart rate, pulse oximetry, respiratory rate, brain activity, eye movement, facial features, body movement, and so on. The physiological data may be used in determining a mood or response of the user to content (e.g., streaming titles, advertisements, or the like) displayed to the user or system responses to interactions of the user with the simulated streaming service. In some examples, an eye tracking device of the physiological monitoring system as described herein may utilize image data associated with the eyes of the user as well as facial features (such as features controlled by the user's corrugator and/or zygomaticus muscles) to determine a portion of a display that is currently the focus of the user's attention.

In some cases, the physiological monitoring system may include a headset device that may include one or more inward-facing image capture devices, one or more outward-facing image capture devices, one or more microphones, and/or one or more other sensors (e.g., an eye tracking device). The sensor data may include image data captured by inward-facing image capture devices as well as image data captured by outward-facing image capture devices. The sensor data may also include sensor data captured by other sensors of the physiological monitoring system, such as audio data (e.g., speech of the user that may be provided to the focus group platform) and other physiological data such as blood pressure, heart rate, pulse oximetry, respiratory rate, brain activity, body movement, and so on. In the current example, the sensor data may be sent to the platform.

In one example, an eye tracking device of the physiological monitoring system may be configured as a wearable appliance (e.g., headset device) that secures one or more inward-facing image capture devices (such as a camera). The inward-facing image capture devices may be secured in a manner that the image capture devices have a clear view of both the eyes as well as the cheek or mouth regions (zygomaticus muscles) and forehead region (corrugator muscles) of the user. For instance, the eye tracking device of the physiological monitoring system may secure to the head of the user via one or more earpieces or earcups in proximity to the ears of the user. The earpieces may be physically coupled via an adjustable strap configured to fit over the top of the head of the user and/or along the back of the user's head. Implementations are not limited to systems including eye tracking and eye tracking devices of implementations are not limited to headset devices. For example, some implementations may not include eye tracking or facial feature capture devices, while other implementations may include eye tracking and/or facial feature capture device(s) in other configurations (e.g., eye tracking and/or facial feature capture from sensor data captured by devices in the user device).

In some implementations, the inward-facing image capture device may be positioned on a boom arm extending outward from the earpiece. In a binocular example, two boom arms may be used (one on either side of the user's head). In this example, either or both of the boom arms may also be equipped with one or more microphones to capture words spoken by the user. In one particular example, the one or more microphones may be positioned on a third boom arm extending toward the mouth of the user. Further, the earpieces of the eye-tracking device of the physiological monitoring system may be equipped with one or more speakers to output and direct sound into the ear canal of the user. In other examples, the earpieces may be configured to leave the ear canal of the user unobstructed. In various implementations, the eye tracking device of the physiological monitoring system may also be equipped with outward-facing image capture device(s). For example, to assist with eye tracking, the eye tracking device of the physiological monitoring system may be configured to determine a portion or portions of a display that the user is viewing (or actual object, such as when the physiological monitoring system is used in conjunction with a focus group environment). In this manner, the outward-facing image capture devices may be aligned with the eyes of the user and the inward-facing image capture device may be positioned to capture image data of the eyes (e.g., pupil positions, iris dilations, corneal reflections, etc.), cheeks (e.g., zygomaticus muscles), and forehead (e.g., corrugator muscles) on respective sides of the user's face. In various implementations, the inward and/or outward image capture devices may have various sizes and figures of merit, for instance, the image capture devices may include one or more wide screen cameras, red-green-blue cameras, mono-color cameras, three-dimensional cameras, high definition cameras, video cameras, monocular cameras, among other types of cameras.

It should be understood, that as the physiological monitoring system discussed herein may not include specialized glasses or other over the eye coverings, the physiological monitoring system is able to capture images of facial expressions and facial muscle movements (e.g., movements of the zygomaticus muscles and/or corrugator muscles) in an unobstructed manner. Additionally, the physiological monitoring system discussed herein may be used comfortably by individuals that wear glasses on a day to day basis, thereby improving user comfort and allowing more individuals to enjoy a positive experience when using personal eye tracking systems.

In some cases, the simulation may also allow the user to provide feedback, such as text-based or verbal, back to the platform. For example, the simulated interface may include a first portion simulating the streaming service and a second portion to allow the user to provide text based comments, input rating (such as via one or more sliders for like/dislike, fear/joy, clarity/confusion, or the like). In still other example, the second portion of the simulation interface may include numerical ratings such as allowing the user to input one to five stars, one or more thumbs up or down, or the like. In another example, the user may provide the feedback via a microphone associated with a television controller or remote control or other audio capture device (e.g., one or more microphones associated with a personal computing device, an audio controlled device, or the like).

In the various example, the platform may receive the image data, audio data, physiological data, feedback, and the like from multiple users each engaged in a simulation associated with a streaming service and/or specific content, a combination thereof, or the like. The platform may then determine analytics or metrics associated with the performance of one or more features of the streaming service, a reception of content, an engagement of content or the user interface, and the like. Accordingly, the platform may aggregate the received data and output various reports that may be used by third parties to evaluate changes to the streaming service interface and/or to assist with content placement. In some cases, the platform may utilize one or more machine learned models to analyze the received data (e.g., the image data, the audio data, the physiological data, the feedback, and the like).

In some examples, the machine learned models may be generated using various machine learning techniques. For example, the models may be generated using one or more neural network(s). A neural network may be a biologically inspired algorithm or technique which passes input data (e.g., image and sensor data captured by the IoT computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

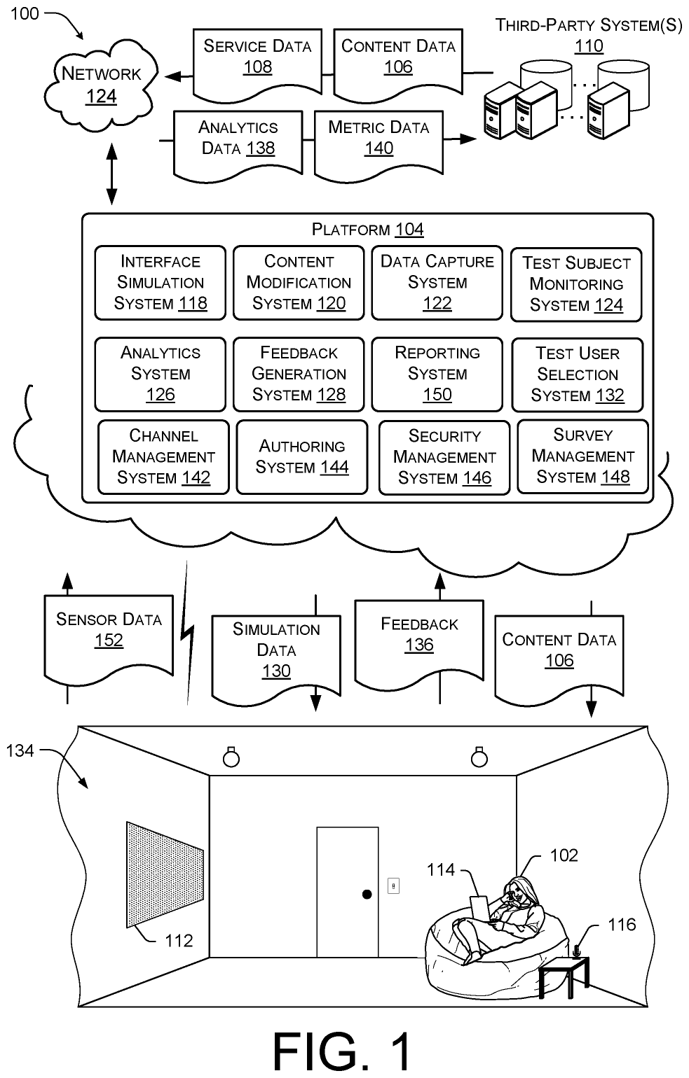

FIG. 1 illustrates an example pictorial view 100 of a user 102 participating in a simulation to evaluate a streaming service and/or streaming service content according to some implementations. As discussed above, a platform 104 may be configured to provide a simulated content consuming environment or application (e.g., provided by a streaming service) accessible to one or more test users, such as user 102, in order to determine one or more metrics associated with the user interface and/or overall experience of the streaming service, content that may be provided by the streaming service (such as one or more titles or visual works), advertisement content (e.g., commercials, product placements, and the like) that may be paired with the content and/or provided by the streaming service via the simulated environment.

In the current example, the platform 104 may receive content data 106 and/or service data 108 from a third party system 110. The content data 106 may include titles (e.g., visual/audio works, movies, games, television shows, episodes, podcasts, webisodes, and/or the like), advertisements (e.g., commercials, banners, product placements, reviews, in-title purchasing options, in-app purchasing options, and the like), or other data that may be consumed by the user 102 via a user device, such as a television 112, mobile electronic device 114 (e.g., smartphone, tablet, notebook, computer, or the like), audio device 116 (e.g., smart speaker system or the like), or the like. The service data 108 may include user interface data (e.g., bottoms, layouts, styles, look and feel data, and the like) associated with a streaming service provided by the third party system 110 as well as performance data (e.g., download and upload speeds, rates, and the like).

The platform 104 may also include one or more systems for generating a simulation of a streaming service providing content with or without advertisements as requested by the third party system 110. For example, the platform 104 may include an interface simulation system 118, a content modification system 120, a data capture system 122, a test subject monitoring system 124, an analytics system 126, a feedback generation system 128, a reporting system 150, a test subject selection system 132, a channel management system 142, an authoring system 144, a security management system 146, a survey system 148, and the like. The platform 104 may also store data, such as the content data 106 and the service data 108 as well as sensor data 152 received from the device 112-116 within an environment 134 associated with the user 102, feedback 136 from the user 102 and associated with the simulated service and content delivery being evaluated, any analytics data 138 or metric data 140 generated by the platform 104 with respect to the simulated service and content delivery being evaluated. The platform may also store recommendations that may be provided to the third party system 110 in addition to or in lieu of the analytics data 138 and/or the metric data 140.

The interface simulation system 118 may be configured to receive the service data 108 from the third party system 110 and to generate simulation data 130 usable to generate a simulated streaming service application on one of the devices 112 or 114 associated with the user 102. For example, the interface simulation system 118 may generate a user interface that substantially mirrors a desired streaming service application with or without additional features that may be added via the service data 108 and/or with or without reduced features that may be removed via the service data 108. In some cases, the interface simulation system 118 may generate the simulation data 130 without receiving any service data 108 from the third party system, such as when a content provider or advertiser desires to evaluate content data 106 on a plurality of streaming services. In some cases, the interface simulation system 118 may include one or more machine learned models and/or networks to generate the simulation data 130. In these cases, the one or more machine learned models and/or networks may be trained using historical service data 108 either received or captured via one or more web crawlers over time.

The content modification system 120 may be configured to modify content data, such as titles or advertisements. For example, the content modification system 120 may be configured to insert advertisements, such as commercials, into titles that are being streamed via the simulation provided by the platform 104. In some cases, the content modification system 120 may include one or more machine learned models and/or networks to modify the content data 106. In these cases, the one or more machine learned models and/or networks may be trained using historical content data 106 either received or captured via one or more web crawlers over time.

The data capture system 122 may be configured to assist with or provide instructions to the devices 112-116 to capture sensor data 134 associated with the user 102 as the user 102 consumes streamed content via the simulation. In some cases, the data capture system 122 may be configured to assist with or provide instructions to the sensors, such as image devices within the environment 134, associated with the devices 112-116, or other sensors located in the environment 134, such as a physiological monitoring system or device worn by the user 102. In some cases, the image devices or other sensors may be incorporated into the environment 134 when the environment 134 is a controlled setting such as a focus group or corporate facility. In other cases, such as a home of the user, the image devices and/or other sensors may be incorporated into the devices 112-116 and may be controlled such as a by a downloadable application in communication with the platform 104.

In some specific examples, the user may input the feedback via a dial or other input device (such as a television remote) that may be adjusted as the content data 106 is consumed. For instance, the user feedback 136 may represent the user's subjective assessment of the user's own reaction at a point in time (e.g., current emotion, current reaction, and the like) as well as a direction of the reaction (e.g., positive or negative) and the magnitude of the reaction (e.g., strong or weaker reactions). For example, the user feedback 136 may include a rating of the user's reaction at a point in time indicating a direction of the user's reaction and the user's assessment of the magnitude of that reaction. In some cases, the user feedback 136 may also be entered with or without an indication of the user's current focus (e.g., a portion of the display, a displayed element, e.g., entity, individual, object, or the like, the entire content displayed, or the like). The user's subjective assessment of the user's own reaction at a point in time may be a reliable indicator of the direction of the user's reaction (e.g., positive or negative).

The test subject monitoring system 124 may be configured to receive the sensor data 152 and to determine data associated with the user 102 consuming the streamed content via the simulation. For example, the test subject monitoring system 124 may be configured to determine an emotional response or state of the user 102 based on image data captured of the face of the user 102. The test subject monitoring system 124 may also determine a field of view or focus of the user 102, such as a portion of the user interface that is a focus of the user 102 at various intervals associated with the simulation. In some cases, the test subject monitoring system 124 may include one or more machine learned models and/or networks to determine features associated with the user 102, such as the emotional response or state. In these cases, the one or more machine learned models and/or networks may be trained using historical sensor data 134.

The analytics system 126 may be configured to determine the analytics data 138 and/or the metric data 140 based at least in part on the output of the test subject monitoring system 124, the sensor data 152, the feedback 136, and the like associated with one or more users, such as users 102. For example, the sensor data 152 may be received from one or more of the devices 112-116 or other sensors associated with the environment 134. The feedback 136 may be input to the devices 112-116 via a user interface (such as a touch screen display), via a microphone or interface on a remote controller (such as a television remote), via a microphone of an audio controlled device, a combination thereof, and/or the like. In some cases, the feedback 136 may be received prior, during, and/or after consumption of the content data 106 (such as to receive user input prior to consumption, during consumption, and/or post consumption).

In some examples, the analytics system 126 may aggregate data associated with multiple simulation instances or sessions for the same content data 106 and/or service data 108. In other words, the same simulation may be presented to a plurality of test users, the data captured during each session may be aggregated, and trends or other metrics may be determined or extracted from the aggregated data. In some cases, the analytics data 138 and/or the metric data 140 may include scores, ranking (e.g., cross comparisons of different content items, such as different titles or different advertisement), receptions ratings, and the like.

In some cases, the analytics data 138 and/or the metric data 140 may also include ratings, scores, rankings, and the like across different streaming services. For example, the same title may be presented on multiple simulations, each simulations associated with a different streaming service provider. The analytics system 126 may then determine the analytics data 138 and/or the metric data 140 as, for instance, a comparative analysis between reception and performance on each of the evaluated streaming service provider applications. It should be understood that in simulating each service provider application, actual users of each service may be evaluated with respect to the corresponding simulation session, such that the analytics data 138 and/or the metric data 140 generated reflects the users of the corresponding streaming service provider application. In some cases, the analytics system 126 may include one or more machine learned models and/or networks to determine the analytics data 138 and/or the metric data 140. In these cases, the one or more machine learned models and/or networks may be trained using historical the analytics data 138 and/or the metric data 140.

The feedback generation system 128 may be configured to generate and/or organize the feedback 136 for the third party system 110 based at least in part on user data received from the user 102 during or after the simulation session. In some cases, the feedback generation system 128 may utilize the generated analytics data 138 and/or metric data 140 to determine recommendations or additional feedback for the third party system 110. In some cases, the feedback generation system 128 may include one or more machine learned models and/or networks to determine the recommendations. In these cases, the one or more machine learned models and/or networks may be trained using historical the analytics data 138, the metric data 140, and user feedback 136.

The reporting system 150 may be configured to report the feedback 136, the analytics data 138, the metric data 140, and the like to the customer (e.g., the third party system 110). In some cases, the reports may include transcripts of any audio provided by the user 102 as well as any trends, recommendations, or the like generated by the platform 104 with respect to one or more simulation sessions associated with a third party's content data 106 and/or service data 108.

The test user selection system 132 may be configured to select test users, such as the user 102, for participation in one or more test simulations. For example, the test user selection system 132 may select the user 102 based at least in part on the service data 108, the content data 106, as well as any information known about the user 102. For example, the test user selection system 132 may utilize demographic information, such as race, sex, gender, address, education, income, content taste profiles (e.g., based on for instance preferred genres, prior ratings, title consumption history, or the like), consumption hours (e.g., hours per day, week, or month consuming streaming services), job description, and the like. In some cases, the test user selection system 132 may include one or more machine learned models and/or networks to determine the recommendations.

The channel management system 142 may include a third-party client interface together with or independent from the authoring system 144. For example, the channel management system 142 may allow each client to customize one or more channels with content data 106 and select users, such as user 102, that may be invited to or otherwise access the content data 106 associated with each channel. For example, the third-party client may customize the arrangement of the display (e.g., multiple display portions, paring of advertisement content with title content, selecting from multiple versions of the same content data, or the like).

In some cases, the channel management system 142 may allow the third party client to select users to consume the content data 106 via an invitation to one or more particular channels. In other cases, the channel management system 142 may allow the third party client to utilize the test subject monitoring system 124 to select users for invitation to a particular channel. For instance, the third party client may configure a first channel for conservative viewers and a second channel for liberal viewers and the test user selection system 124 may utilize demographic information, such as race, sex, gender, address, education, income, content taste profiles (e.g., based on for instance preferred genres, prior ratings, title consumption history, or the like), consumption hours (e.g., hours per day, week, or month consuming streaming services), job description, and the like to select appropriate users for each of the channels as indicated by the third party client.

The authoring system 144 may allow the third party client to author and/or customize the content data 106. For example, the authoring system 144 may provide video editing tools that are automated (e.g., machine learned, preprogrammed, or the like) to add effects, features, lighting, snipping, color matching, and the like with respect to the content data 106. The authoring system 144 may also provide tools for the third party client to arrange content data 106, such as advertisement placement, product placement within the content, adjusting time of day, weather, setting, (e.g., country v. city), style, (e.g., cartoon graphical styles), and the like. For instance, the authoring system 144 tools may allow a client to replace similar products, such as a first soda drink associated with a first retailer with a second soda drink associated with a competitor retailer.

In some cases, the authoring system 144 may also allow the third party client to generate insert and/or arrange instructions, prompts, questions (such as related to the survey system 148), promos, or the like for the user on the display of the devices 112-116. The authoring system 144 may also allow the third party client to apply randomization, sequences, intervals, triggers (e.g., time based, content based, user information based, user response data based, or the like) to a channel or content data 106. For example, if a user is providing sensor data 152 and/or feedback 136 that indicates a response or reception greater than or equal to one or more thresholds, the platform 104 may cause a particular prompt or question to be presented to that user. In this manner, the authoring system 144 may allow the third party client to customize an experience of a channel based on substantially real time feedback to improve the overall data collection during the session or consumption event.

The security management system 146 may allow for the third party client to adjust the security or accessibility of a channel or other content data 106 by the users of the platform 104. For example, the security management system 146 may allow the third party client to set permissions, passwords, encryption protocols, and the like. The security management system 146 may also allow the third party client to generate access codes that may be applied to the content data 106, the channels, and/or provided to users to allow access to particular content data 106 and/or channels. In some cases, the security management system 146 may allow for the use of biometric data capture or authentication, such that the platform 104 as well as the third party client may verify the identity of the user prior to allowing access to the particular content data 106 and/or channel.

In this manner, the channel management system 142, the authorizing system 144, and/or the security management system 146 allows the third party client to manage and/or control the content experience encountered by each individual user that is selected to or authorized to consume the content data 106 and/or access a channel.

The survey system 148 may be configured to prompt or otherwise present questions (such as open ended, multiple choice, true/false, positive/negative, and the like) either prior to, during, or after consumption of the content data 106. The responses may be provided back to the platform 104 as part of the feedback 136. In some cases, the survey system 148 may cause the presentation of the content data 106 to pause or suspend while the survey questions are displayed to the user. In some cases, the survey system 148 may cause a desired position of the content data 106 to replay or recycle while the survey questions are displayed (such as when the questions are presented after the content data 106 is fully consumed). In yet other cases, the survey system 148 may cause the presentation of the content data 106 in additional arrangements (e.g., concurrent multiple screens or displays, changes in order or chronology of the output of the content data 106, paring of temporally disparate portions of the content data 106, highlighting, adding icons or indicators, or otherwise altering the original content data 106, such as during a playback, or the like). In this manner, the platform 104 may present alternative endings, alternative advertisements, alternative product placements, alterative styles, alternative character features (e.g., hair color, posture, attitude, stance, clothing, and the like) and receive feedback 136 from the user on each during a single session.

In the current example, the user 102 does not include a physiological monitoring system or device in addition to the electronic device 114 for capturing additional physiological data, as discussed herein. However, it should be understood, that in some examples the user 102 may utilize additional devices (not shown) to capture additional data, such as the physiological data, that may be processed and/or analyzed by the platform 104 to generate the analytics data 138 and/or the metric data 140 as well as recommendations for the third party system 110 with respect to the service and/or content being evaluated.

In the current example, a single third party system 110 is illustrated, however, it should be understood that any number of third party systems 110 may provide service data 108 and/or content data 106 to the platform 104 for evaluation by one or more test users, such as user 102. For example, a content service provider may provide service data 108 and/or content data 106 to evaluate the reception of the service by the user 102 and/or the reception of the content data 106 by the user 102. For instance, the evaluation may assist with the content service provider in updating or modifying the streaming application interface, selecting content to provide via their streaming application, selecting advertisements to provide via their streaming application, selecting combinations of titles and advertisements to provide via their streaming application, or the like.

As another example, the third party system may be a content creator that may provide the content data 106 for evaluation across a plurality of streaming services to determine if one or more streaming services should be selected or approached for providing their content to the streaming service users. As yet another example, the third party system may be a product provider, agency, or advertisers that may provide the content data 106 for evaluation across a plurality of streaming services and titles to determine if one or more advertisements should be provided by a streaming service and/or to select titles to pair with the advertainments or products. In some cases, the platform 102 may also assist the provider, agency, or advertisers in determining if a titles or services user base is receptive to particular advertisement, particular products, or types of advertisement, or the like.

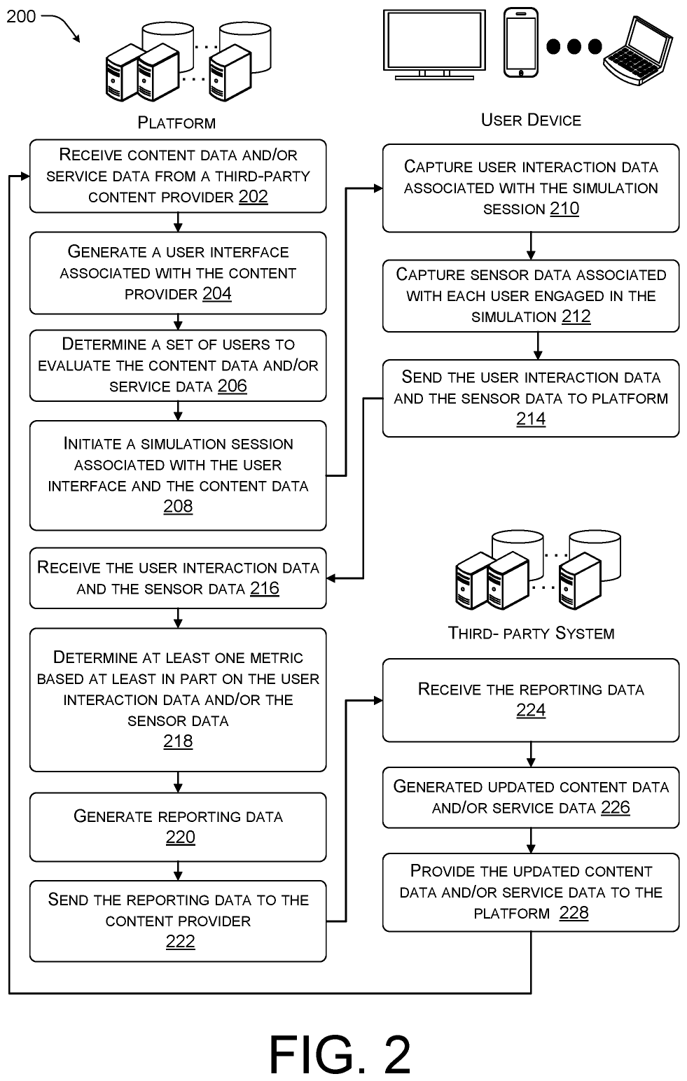

FIGS. 2-5 are flow diagrams illustrating example processes associated with the platform of FIG. 1 according to some implementations. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 illustrates an example flow diagram showing an illustrative process 200 for providing a platform for evaluating streaming services and/or streaming service content according to some implementations. As discussed above, a platform may be configured to provide a simulated content consuming environment or application (e.g., provided by a streaming service) accessible to one or more test users in order to determine one or more metrics associated with the user interface and/or overall experience of the streaming service, content that may be provided by the streaming service (such as one or more titles or visual works), advertisement content (e.g., commercials, product placements, and the like) that may be paired with the titles, and/or provided by the streaming service via the simulated environment.

At 202, a platform, such as the platform 104 of FIG. 1, may receive content data and/or service data from a third party content provider. The content data may include titles (e.g., visual/audio works, movies, games, television shows, episodes, podcasts, webisodes, and/or the like), advertisements (e.g., commercials, banners, product placements, reviews, in-title purchasing options, in-app purchasing options, and the like), or other data that may be consumed by one or more users via various types of user devices, such as televisions, mobile electronic devices (e.g., smartphone, tablet, notebook, computer, or the like), audio devices (e.g., smart speaker system or the like), or the like. The service data may include user interface data (e.g., bottoms, layouts, styles, look and feel data, and the like) associated with a streaming service provided by the third party content provider as well as performance data (e.g., download and upload speeds, rates, and the like) that the third party content provider would prefer that the platform replicate during the evaluation sessions with the test users.

At 204, the platform may generate a user interface associated with the content provider. For example, the platform may select a user interface from one or more predetermined user interfaces that are associated with various different streaming services. In some cases, the platform may modify the selected user interface based on the service data received, such as when a third party content provider is testing a new interface feature or performance feature. In some cases, the user interface may be selected by a content provider, such that the content provider may select various interfaces of various services to test appeal, reception, response, or performance of a particular title, advertisement, or other content item with one or more streaming service providers interface, application, or users.

In some cases, the platform may include one or more machine learned models and/or networks to generate the user interface or otherwise simulate the streaming experience of a specific streaming service provider. In these cases, the one or more machine learned models and/or networks may be trained using historical service data either received or captured via one or more web crawlers over time. In some cases, the training data may be captured from the specific streaming service providers applications or provided by the streaming service provider directly.

At 206, the platform may determine a set of users to evaluate the content data and/or the service data. For example, the platform may select users associated with a streaming service provider that provided the content data and/or service data, such that the platform may evaluate the content data and/or service data with known users of the application provided by the streaming service provider. In other cases, the platform may select the set of users based on characteristics of the content data and user data known about each potential test users. For instance, the platform may select the set of users based on a genre, category, feature, length, type, actors or actresses, publisher, and the like associated with the content data together with corresponding user data including demographic information, viewing preferences, prior ratings, title consumption history, consumption hours, employment data, and the like. As an illustrative example, the platform may select multiple users from each available streaming service that have consumed more than a threshold number of hours within a genre corresponding to the content data and include various other factors (which may or may not be provided by the third party client), such as an income above an income threshold, subscribed to above a number of streaming services (e.g., a service provider threshold), and resides within a defined geographic area.

In some cases, the set of users may be selected to be greater than a threshold number of test users (the user threshold may or may not be provided by the third party client). In some cases, the set of users may also include a diversification threshold, such as no more users within the set of users having an income within each defined range, reside within each defined geographic region, matching a demographic threshold, or the like.

At 208, the platform may initiate a simulation session associated with the user interface and the content data. For example, the platform may provide to each user device assigned to a user within the set of users a link or other means to access the simulated user interface for a simulation session associated with the content data and/or service data, as described herein. Each user may then initiate the simulation session either at a desired time or when the user is ready to consume the content (such as if the third party client desires the evaluation to be performed at a time that each user typically consumes content data, e.g., in accordance with the user's customary practices).

At 210, the user device associated with each user of the set of users may capture user interaction data associated with the simulation session. For example, the user device may track each engagement (such as a selection) with the user interface of the simulation session. For example, each time a user pauses a streaming title while consuming may be recorded by the user device. As another example, the user device may record each title that the user views or otherwise inspects prior to selection a title for consumption (such as when multiple titles are offered during the simulation session). The user device may also capture interaction data with one or more advertisements or purchasing options made available via the user interface (such as when a third party client is evaluating a buy now button or the like).

At 212, the user device associated with each user of the set of users may capture user sensor data associated with the simulation session. For example, an image capture device of the user device may capture image data of the user while the user consumes the content data via the user interface and application of the simulation session. Likewise, a microphone associated with the user device may capture audio data of the user while the user consumes the content data via the user interface and application of the simulation session.

At 214, the user device associated with each user of the set of users may send the interaction data and the sensor data to the platform and, at 216, the platform may receive the user interaction data and the sensor data. For example, the user device may send the interaction data and the sensor data via one or more networks. In some cases, additional sensors may be used to capture sensor data associated with the user while consuming the content data within the simulation session. For example, a physiological monitoring system may be worn by the user to capture physiological data associated with the user. In these cases, the additional sensors may either provide the sensor data directly to the platform via one or more networks or to the user device (such as via Bluetooth, a local area wireless network, or the like) to be provided to the platform together with the sensor data and interaction data captured by the user device.

At 218, the platform may determine at least one metric based at least in part on the user interaction data and/or the sensor data. For example, the metrics may include performance metrics, engagement metrics, response metrics (e.g., an emotional response of each user or individual users), reception metrics, consumption metrics (length of consumption, number of pauses, starts, stops, etc., amount of a content data consumed, and the like), user evaluation metrics, and the like. In some cases, the platform may evaluate the metrics for individual users and, in other cases, the platform may aggregate the interaction data and/or sensor data to determine the metrics (such as trends over specific demographics or the like).

In some cases, the platform may include one or more machine learned models and/or networks to generate the metrics based at least in part on the interaction data and sensor data received from the user devices. In these cases, the one or more machine learned models and/or networks may be trained using prior session data (e.g., interaction data and/or sensor data). In some case, the training data may be captured from the specific streaming service providers applications.

At 220, the platform may generate reporting data for the third party client and, at 222, the platform may send the reporting data to the third party client. For example, the platform may include the one or more metrics together with any trends or other factors that may be extrapolated from the captured data. In some cases, the platform may also provide the raw sensor data and/or interaction data, such as hours of content consumed by each user or the like. The platform may also receive user feedback data from each user, such as via a response to a questionary provided to each test user after the simulation session has expired. In these cases, the user feedback data may also be organized and provided in the reporting data.

At 224, the third party client may receive the reporting data and, at 226, the third party client may generate updated content data and/or service data. For example, the third party client may alter or change an advertisement that the third party client intended to run with particular content data or for a particular set of consumers.

At 228, the third party client may provide the updated content data to the platform and the process 200 may return to 202 in order to evaluate the updated content data and/or service data, as described above.

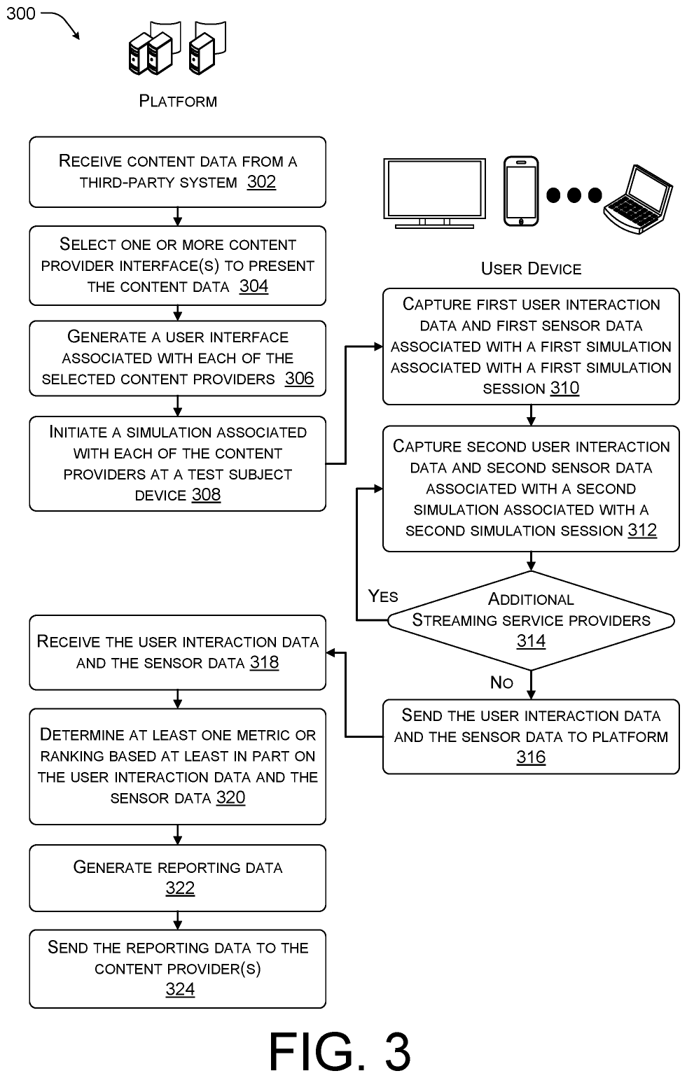

FIG. 3 illustrates another example flow diagram showing an illustrative process 300 for providing a platform for evaluating streaming services and/or streaming service content according to some implementations. As discussed above, a platform may be configured to provide a simulated content consuming environment or application (e.g., provided by a streaming service) accessible to one or more test users in order to determine one or more metrics associated with the user interface and/or overall experience of the streaming service, content that may be provided by the streaming service (such as one or more titles or visual works), advertisement content (e.g., commercials, product placements, and the like) that may be paired with the titles, and/or provided by the streaming service via the simulated environment.

At 302, a platform, such as the platform 104 of FIG. 1, may receive content data from a third party content provider. The content data may include titles (e.g., visual/audio works, movies, games, television shows, episodes, podcasts, webisodes, and/or the like), advertisements (e.g., commercials, banners, product placements, reviews, in-title purchasing options, in-app purchasing options, and the like), or other data that may be consumed by one or more users via various types of user devices, such as televisions, mobile electronic devices (e.g., smartphone, tablet, notebook, computer, or the like), audio devices (e.g., smart speaker system or the like), or the like.

At 304, the platform may select one or more content provider interfaces (or applications) to present the content data. In some cases, the user interface may be selected by a content provider, such that the content provider may select various interfaces of various services to test appeal, reception, response, or performance of a particular title, advertisement, or other content item with one or more streaming service providers interfaces, applications, or users. In other cases, the platform may select the content provider interfaces based at least in part on features associated with the content data, such as genre, category, feature, length, type, actors or actresses, publisher, and the like and content interface data, such as audience demographic data, audience employment data, audience consumption history data (e.g., titles, genres and the like), audience purchasing data, and the like.

At 306, the platform may generate a user interface associated with each of the selected content providers. For example, the platform may generate the user interface from one or more predetermined user interfaces that are associated with various different streaming services and any modifications requested by the third party client or content provider. In some cases, the platform may include one or more machine learned models and/or networks to generate the user interface or otherwise simulate the streaming experience of a specific streaming service provider. In these cases, the one or more machine learned models and/or networks may be trained using historical service data either received or captured via one or more web crawlers over time. In some cases, the training data may be captured from the specific streaming service providers applications or provided by the streaming service provider directly.

At 308, the platform may initiate a simulation session associated with the user interface and the content data. For example, the platform may provide to each user device assigned to a user within the set of users a link or other means to access the simulated user interface for a simulation session associated with the content data and/or service data, as described herein. Each user may then initiate the simulation session either at a desired time or when the user is ready to consume the content (such as if the third party client desires the evaluation to be performed at a time that each user typically consumes content data, e.g., in accordance with the user's customary practices).

At 310, the user device associated with each user of the set of users may capture first user interaction data and first sensor data associated with a first simulation session. For example, the user device may track each engagement (such as a selection) with the user interface of the simulation session (such as associated with a first user interface, application, or streaming service providers systems). For example, each time a user pauses a streaming title while consuming may be recorded by the user device. As another example, the user device may record each title that the user views or otherwise inspects prior to selection a title for consumption (such as when multiple titles are offered during the simulation session). The user device may also capture first interaction data with one or more advertisement or purchasing option made available via the user interface (such as when a third party client is evaluating a buy now button or the like). The user device associated with each user of the set of users may capture first sensor data associated with the first simulation session. For example, an image capture device of the user device may capture image data of the user while the user consumes the content data via the user interface and application of the simulation session. Likewise, a microphone associated with the user device may capture audio data of the user while the user consumes the content data via the user interface and application of the simulation session.

At 312, the user device associated with each user of the set of users may capture second user interaction data and second sensor data associated with a second simulation session. For example, the user device may track each engagement (such as a selection) with the user interface of the second simulation session (such as associated with a second user interface, application, or streaming service providers systems different than the those of the first simulation session). For example, each time a user pauses a streaming title while consuming may be recorded by the user device. As another example, the user device may record each title that the user views or otherwise inspects prior to selection a title for consumption (such as when multiple titles are offered during the simulation session). The user device may also capture second interaction data with one or more advertisement or purchasing option made available via the user interface (such as when a third party client is evaluating a buy now button or the like). The user device associated with each user of the set of users may capture second sensor data associated with the second simulation session. For example, an image capture device of the user device may capture image data of the user while the user consumes the content data via the user interface and application of the simulation session. Likewise, a microphone associated with the user device may capture audio data of the user while the user consumes the content data via the user interface and application of the simulation session.

At 314, the simulation application on the user device may determine if there are additional streaming service providers user interfaces to test with respect to the content data provided by the content provider. If there are additional streaming service providers then the process 300 returns to 312 and test another user interface via an additional simulation session. However, if there are no additional streaming service providers then the process proceeds to 316.

At 316, the user device associated with each user may send the interaction data and the sensor data for each simulation session to the platform and, at 318, the platform may receive the user interaction data and the sensor data for each session. For example, the user device may send the interaction data and the sensor data via one or more networks. In some cases, additional sensors may be used to capture sensor data associated with the user while consuming the content data within the simulation session. for example, a physiological monitoring system may be worn by the user to capture physiological data associated with the user. In these cases, the additional sensors may either provide the sensor data directly to the platform via one or more networks or to the user device (such as via Bluetooth, a local area wireless network, or the like) to be provided to the platform together with the sensor data and interaction data captured by the user device.

At 320, the platform may determine at least one metric based at least in part on the user interaction data and/or the sensor data. For example, the metrics may include performance metrics, engagement metrics, response metrics (e.g., an emotional response of each user or individual users), reception metrics, consumption metrics (length of consumption, number of pauses, starts, stops, etc., amount of a content data consumed, and the like), user evaluation metrics, and the like. In some cases, the platform may evaluate the metrics for individual users and, in other cases, the platform may aggregate the interaction data and/or sensor data to determine the metrics (such as trends over specific demographics or the like).

In some cases, the platform may include one or more machine learned models and/or networks to generate the metrics based at least in part on the interaction data and sensor data received from the user devices. In these cases, the one or more machine learned models and/or networks may be trained using prior session data (e.g., interaction data and/or sensor data). In some cases, the training data may be captured from the specific streaming service providers applications.

At 322, the platform may generate reporting data for the third party client and, at 324, the platform may send the reporting data to the third party client. For example, the platform may include the one or more metrics together with any trends or other factors that may be extrapolated from the captured data. In some cases, the platform may also provide the raw sensor data and/or interaction data, such as hours of content consumed by each user or the like. The platform may also receive user feedback data from each user, such as via a response to a questionary provided to each test user after the simulation session has expired. In these cases, the user feedback data may also be organized and provided in the reporting data.

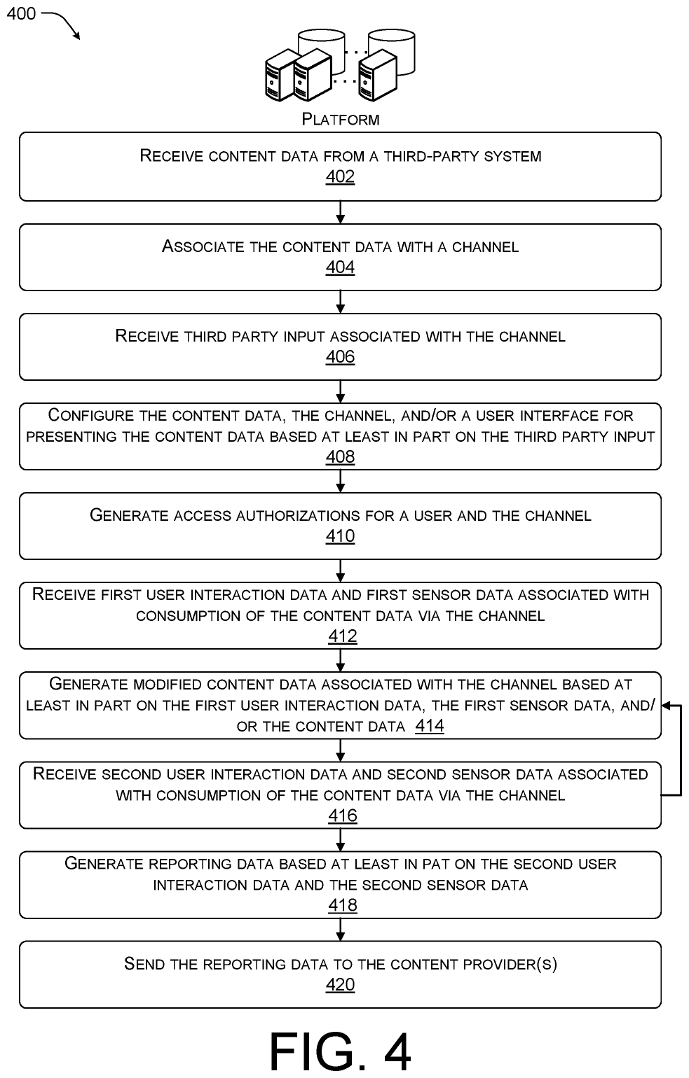

FIG. 4 illustrates another example flow diagram showing an illustrative process 400 for providing a platform for evaluating streaming services and/or streaming service content according to some implementations. In the current example, the platform may be configured to update, modify, or otherwise tailor the experience of the user consuming content data based on the user interactions (e.g., feedback data and/or sensor data) as well as third party client's inputs or settings associated with a channel containing the content data being consumed.

At 402, a platform, such as the platform 104 of FIG. 1, may receive content data from a third party content provider. The content data may include titles (e.g., visual/audio works, movies, games, television shows, episodes, podcasts, webisodes, and/or the like), advertisements (e.g., commercials, banners, product placements, reviews, in-title purchasing options, in-app purchasing options, and the like), or other data that may be consumed by one or more users via various types of user devices, such as televisions, mobile electronic devices (e.g., smartphone, tablet, notebook, computer, or the like), audio devices (e.g., smart speaker system or the like), or the like.

At 404, the platform may associate the content data with a channel. For instance, the third party client may indicate the channel to associate the content with via a client system or interface or the like. In some cases, the third party client may indicate or create a channel for use with the content data via a client interface or downloadable application associated with the platform, as discussed herein. For instance, the third party client may select the content data or content item for including in one or more channels.

At 406, the platform may receive third party input associated with the channel. For example, the platform may allow each client to customize each channel with content data and users that may be invited to or otherwise access the content data associated with each channel (e.g., a class of users, type of users, or based on various characteristics of the individual users). As some non-limiting illustrative examples of the third party input or configuration of a channel, the third-party client may customize the arrangement of the display (e.g., placing multiple windows and the like), configure multiple display portions or windows with content (e.g., survey content, instructional content, title content, advertisement content, paring of content within a channel, combining of advertisement content with title content, selecting from multiple versions of the same content data, ordering or creating triggers for displaying particular content data, titles, or items, or the like).

In some cases, the platform may allow the third party client to select types of users (e.g., based on characteristics of the users) or specific users (e.g., by name, identity, identifiers, or the like) to consume the content data via one or more particular channels. For instance, the third party client may configure a first channel for conservative viewers and a second channel for liberal viewers, such as via demographic information (e.g., race, sex, gender, address, education, income, content taste profiles, prior ratings, title consumption history, or the like), consumption hours (e.g., hours per day, week, or month consuming streaming services), job description, and the like to select appropriate users within a desired class of users for each of the channels as indicated by the third party client.

The platform may also allow the third party client to author and/or customize the content data within each channel. For example, the platform may provide video editing tools that are automated (e.g., machine learned, preprogrammed, or the like) to add effects, features, lighting, snipping, color matching, and the like with respect to the content data. The platform may also provide tools for the third party client to place advertisements or products within content data, adjust features (e.g., time of day, weather, setting, theme, style, and the like), and the like.

In some cases, the platform may also allow the third party client to generate insert and/or arrange instructions, prompts, questions (such as related to a survey), promos, or the like for presentation to users within a channel.

At 408, the platform may configure the content data, the channel, and/or a user interface for presenting the content data based at least in part on the third party input. For example, the platform may configure the content data, channel, and/or user interface in a manner desired by the third party user as discussed above.

At 410, the platform may generate access authorizations for a user and the channel. For example, if the user is selected for inclusion in the channel to consume the associated content data, then the platform may provide the user with a link, access code, password generation portal, or other credentials that may allow the user to access the content as well as identify the user to the platform when the user accesses the channel via specific credentials. In some cases, the credentials may include biometric confirmation of the identity of the user to ensure that the user consuming the content data is the user invited to participate in rating, reviewing, critiquing, the content data. In this manner, the platform may ensure confidentiality and that the user meets the desired class of users desired by the third party client.

At 412, the platform may receive first user interaction data and first sensor data associated with consumption of the content data via the channel from, for instance, a user device. For example, the user device may track each engagement (such as a selection) with the user interface of the simulation session (such as associated with a first user interface, application, or streaming service providers systems). In some cases, each time a user pauses a streaming title while consuming may be recorded by the user device. As another example, the user device may record each title that the user views or otherwise inspects prior to selection a title for consumption (such as when multiple titles are offered during the simulation session). The user device may also capture first interaction data with one or more advertisement or purchasing option made available via the user interface (such as when a third party client is evaluating a buy now button or the like). The user device associated with each user of the set of users may capture first sensor data associated with the first simulation session. For example, an image capture device of the user device may capture image data of the user while the user consumes the content data via the user interface and application of the simulation session. Likewise, a microphone associated with the user device may capture audio data of the user while the user consumes the content data via the user interface and application of the simulation session.

At 414, the platform may generate modified content data associated with the channel based at least in part on the first user interaction data, the first sensor data, and/or the content data. For example, the platform may modify or otherwise change the content data being delivered via the channel based on the first user interaction data, the first sensor data, and/or the consumed content data. As a non-limiting illustrative example, the platform may trigger modifications to the content data based at least in part on one or more thresholds being meet or exceeded by a user (e.g., a consumption time, consumption of specific titles, a magnitude, positive or negative, of a rating, a quantity of user feedback, or the like). In some cases, the platform may utilize one or more machine learned models trained on prior feedback data and content data to determine if a trigger is activated based on the user's feedback to a specific content item. In this manner, the machine learning models may assist in selecting the modifications to the content data and/or selecting subsequent or additional (e.g., second, third, and the like) content items for presentation of the user via the channel. In some specific examples, the platform may modify the content data for all users of the platform, while in other cases, the platform may modify the content data only for the specific user.

At 416, the platform may receive second user interaction data and second sensor data associated with consumption of the content data via the channel. The second user interaction data and/or sensor data may be similar to those discussed above with respect to the first content data. In this example, the process 400 may return to 414 and generate additional modified content data for the user and/or the channel. In other cases, the process 400 may advance to 418.

At 418, the platform may generate reporting data for the third party client and, at 420, the platform may send the reporting data to the third party client. For example, the platform may include one or more metrics together with any trends or other factors that may be extrapolated from the captured data. In some cases, the platform may also provide the raw sensor data and/or interaction data, such as hours of content consumed by each user or the like. The platform may also receive user feedback data from each user, such as via a response to a questionary provided to each test user after the simulation session has expired. In these cases, the user feedback data may also be organized and provided in the reporting data. In some cases, the reporting data may be presented to the third party client via a dashboard that may be accessible through the platform or a downloadable application associated with the platform.

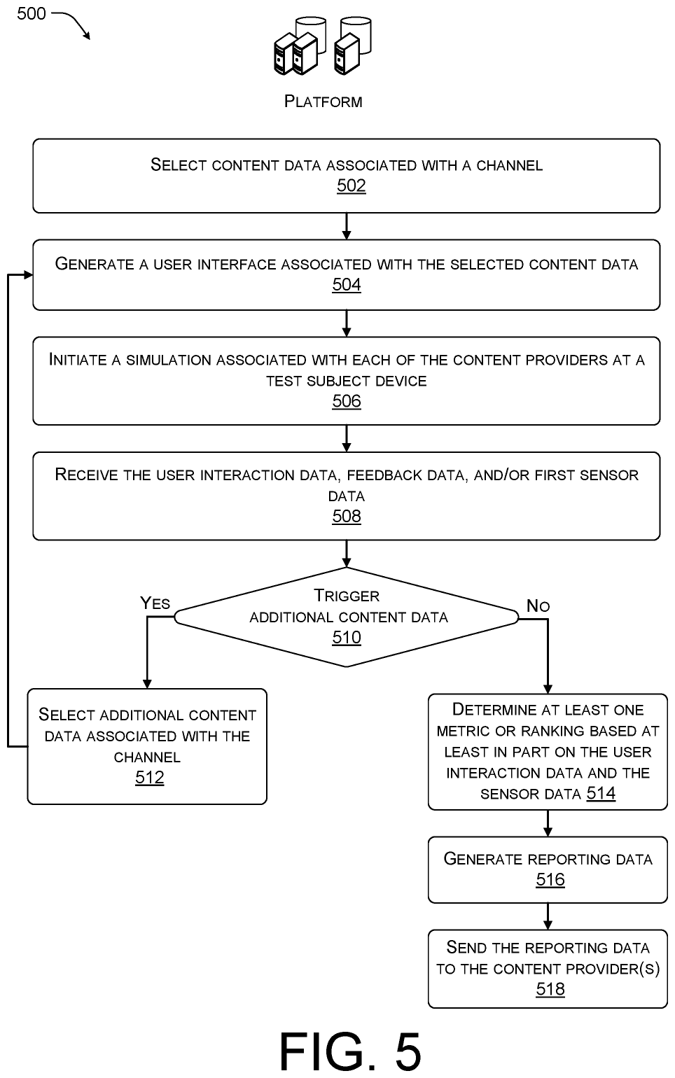

FIG. 5 illustrates an example flow diagram showing an illustrative process for a third party client to access a platform for evaluating streaming services and/or streaming service content according to some implementations. In some cases, the third party client may adjust a channel to trigger different content data based on interaction data, feedback data, and/or sensor data associated with a user consuming content via a channel.

At 502, the platform may select content data associated with a channel. For example, a user may access a channel via one or more credentials to consume content data. In these examples, the platform may select the content data based at least in part on the input of the third party client as well as features or characteristics known about the user.

At 504, the platform may generate a user interface associated with the selected content data. For example, the platform may generate the user interface from one or more predetermined user interfaces that are associated with various different streaming services and any modifications requested by the third party client as well as any settings or designations associated with the channel. In some cases, the platform may include one or more machine learned models and/or networks to generate the user interface or otherwise simulate the streaming experience of a specific streaming service provider. In these cases, the one or more machine learned models and/or networks may be trained using historical service data either received or captured via one or more web crawlers over time. In some cases, the training data may be captured from the specific streaming service providers applications or provided by the streaming service provider directly.

At 506, the platform may initiate a simulation session associated with the user interface and the content data. For example, the platform may provide to each user device assigned to a user within the set of users a link or other means to access the simulated user interface for a simulation session associated with the content data and/or service data, as described herein. Each user may then initiate the simulation session either at a desired time or when the user is ready to consume the content (such as if the third party client desires the evaluation to be performed at a time that each user typically consumes content data, e.g., in accordance with the user's customary practices).

At 508, the platform may receive user interaction data, feedback data, and/or sensor data associated with a simulation session within a channel. For example, a user device may track each engagement (such as a selection) with the user interface of the simulation session (such as associated with a user interface, application, or streaming service providers systems). For example, each time a user pauses a streaming title while consuming may be recorded by the user device. As another example, the user device may record each title that the user views or otherwise inspects prior to selection a title for consumption (such as when multiple titles are offered during the simulation session). The user device may also capture first interaction data with one or more advertisements or purchasing options made available via the user interface (such as when a third party client is evaluating a buy now button or the like). The user device associated with each user of the set of users may capture first sensor data associated with the first simulation session. For example, an image capture device of the user device may capture image data of the user while the user consumes the content data via the user interface and application of the simulation session. Likewise, a microphone associated with the user device may capture audio data of the user while the user consumes the content data via the user interface and application of the simulation session and to provide the audio data or a transcript of the audio data back to the platform as part of the feedback data.

At 510, the platform may determine if the consumption of the content data within the simulation session in the channel by the user triggers additional content (and/or modified content data as discussed herein). For example, if the user interaction data, feedback data, and/or sensor data causes the platform to trigger additional content data, then the process 500 advances to 512. Otherwise, the process 500 moves to 514. As some examples, one or more machine learned model trained on prior collected content data, third party client inputs, user interaction data, feedback data, and/or sensor data may receive as an input the user interaction data, the feedback data, and/or the sensor data and output the trigger event outcome. In other cases, the user interaction data, the feedback data, and/or the sensor data may be compared to one or more thresholds to determine if the additional content data is triggered.

At 512, the platform may select additional content data associated with the channel. For example, the platform may select the additional content data based at least in part on the input of the third party client as well as features or characteristics known about the user as well as the trigger event (e.g., the cause of the trigger). The additional content data may also be selected based on the user interaction data, the feedback data, and/or the sensor data. Once the additional content data is selected, the process 500 may return to 504.

At 514, the platform may determine at least one metric based at least in part on the user interaction data and/or the sensor data. For example, the metrics may include performance metrics, engagement metrics, response metrics (e.g., an emotional response of each user or individual users), reception metrics, consumption metrics (length of consumption, number of pauses, starts, stops, etc., amount of a content data consumed, and the like), user evaluation metrics, and the like. In some cases, the platform may evaluate the metrics for individual users and, in other cases, the platform may aggregate the interaction data and/or sensor data to determine the metrics (such as trends over specific demographics or the like).

At 516, the platform may generate reporting data for the third party client and, at 518, the platform may send the reporting data to the third party client. For example, the platform may include the one or more metrics together with any trends or other factors that may be extrapolated from the captured data. In some cases, the platform may also provide the raw sensor data and/or interaction data, such as hours of content consumed by each user or the like. The platform may also receive user feedback data from each user, such as via a response to a questionary provided to each test user after the simulation session has expired. In these cases, the user feedback data may also be organized and provided in the reporting data. In some cases, the reporting data may be presented to the third party client via a dashboard that may be accessible through the platform or a downloadable application associated with the platform.

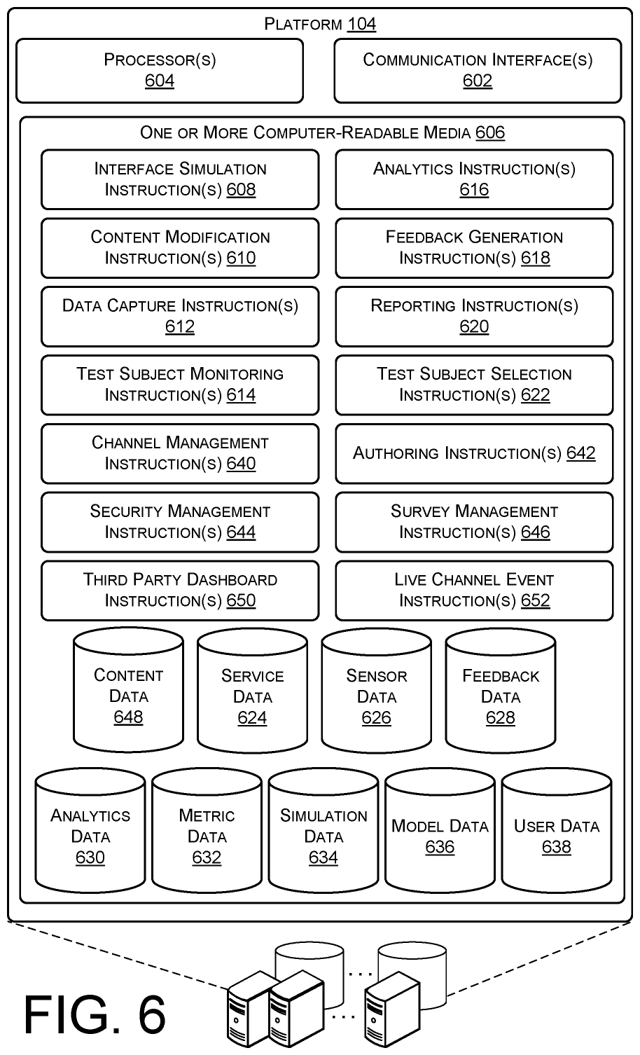

FIG. 6 illustrates an example platform 104 according to some implementations. In the illustrated example, the platform 104 includes one or more communication interfaces 602 configured to facilitate communication between one or more networks, one or more system (e.g., user devices and third party systems). The communication interfaces 602 may also facilitate communication between one or more wireless access points, a master device, and/or one or more other computing devices as part of an ad-hoc or home network system. The communication interfaces 602 may support both wired and wireless connection to various networks, such as cellular networks, radio, WiFi networks, short-range or near-field networks (e.g., Bluetooth®), infrared signals, local area networks, wide area networks, the Internet, and so forth.

The platform 104 includes one or more processors 604, such as at least one or more access components, control logic circuits, central processing units, or processors, as well as one or more computer-readable media 606 to perform the function of the platform 104. Additionally, each of the processors 604 may itself comprise one or more processors or processing cores.

Depending on the configuration, the computer-readable media 606 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 604.

Several modules such as instruction, data stores, and so forth may be stored within the computer-readable media 606 and configured to execute on the processors 604. For example, as illustrated, the computer-readable media 606 stores interface simulation instructions 608, content modification instructions 610, data capture instructions 612, test subject monitoring instructions 614, analytics instructions 616, feedback generation instructions 618, reporting instructions 620, and test subject selection instructions 622 as well as other instructions such as an operating system. The computer-readable media 606 may also store data, such as the content data 648, service data 624, sensor data 626, feedback data 628, analytics data 630, metric data 632, simulation data 634, user data 638, and the like. The computer-readable media 606 may also store one or more machine learned models 636, as discussed herein.

The interface instructions 608 may be configured to receive the service data 624 and to generate simulation data 634 usable to generate a simulated streaming service application on one of the devices associated with a test user. For example, the interface simulation instructions 608 may generate a user interface that substantially mirrors a desired streaming service application with or without additional features that may be added via the service data 624 and/or with or without reduced features that may be removed via the service data 624. In some cases, the interface simulation instructions 608 may generate the simulation data 634 without receiving any service data 624. In some cases, the interface simulation instructions 608 may include one or more machine learned models and/or networks 636 to generate the simulation data 634. In these cases, the one or more machine learned models and/or networks may be trained using historical service data 624 either received or captured via one or more web crawlers over time.

The content modification instructions 610 may be configured to modify content data, such as titles or advertisements. For example, the content modification instructions 610 may be configured to insert advertisements, such as commercials, into titles that are being streamed via the simulation provided by the platform 104. In some cases, the content modification instructions 610 may include one or more machine learned models and/or networks 636 to modify the content data 648. In these cases, the one or more machine learned models and/or networks may be trained using historical content data 648 either received or captured via one or more web crawlers over time.

The data capture instructions 612 may be configured to assist with or provide instructions to the devices to capture sensor data 626 associated with each test user as each test user consumes streamed content via the simulation. In some cases, the data capture instructions 612 may be configured to assist with or provide instructions to the sensors, such as image devices or other sensors located in the environment of the test user. In some cases, the image devices or other sensors may be incorporated into the environment when the environment is a controlled setting such as a focus group or corporate facility.

The test subject monitoring instructions 614 may be configured to receive the sensor data 626 and to determine data associated with the user consuming the streamed content via the simulation. For example, the test subject monitoring instructions 614 may be configured to determine an emotional response or state of the user based on image data captured of the face of the user. The test subject monitoring instructions 614 may also determine a field of view or focus of the user such as a portion of the user interface that is a focus of the user at various intervals associated with the simulation. In some cases, the test subject monitoring instructions 614 may include one or more machine learned models and/or networks to determine features associated with the user, such as the emotional response or state. In these cases, the one or more machine learned models and/or networks 636 may be trained using historical sensor data 626.

The analytics instructions 616 may be configured to determine the analytics data 630 and/or the metric data 632 based at least in part on the output of the test subject monitoring instructions 614, the sensor data 624, the feedback 628, and the like associated with one or more users, such as users. For example, the analytics instructions 616 may aggregate data associated with multiple simulation instances or sessions for the same content data 648 and/or service data 624. In other words, the same simulation may be presented to a plurality of test users, the data captured during each session may be aggregated, and trends or other metrics may be determined or extracted from the aggregated data. In some cases, the analytics data 630 and/or the metric data 632 may include scores, ranking (e.g., cross comparisons of different content items, such as different titles or different advertisement), receptions ratings, and the like.

In some cases, the analytics data 630 and/or the metric data 632 may also include ratings, scores, rankings, and the like across different streaming services. For example, the same title may be presented on multiple simulations, each simulation associated with a different streaming service provider. The analytics system 126 may then determine the analytics data 630 and/or the metric data 632 as, for instance, a comparative analysis between reception and performance on each of the evaluated streaming service provider applications. It should be understood that in simulating each service provider application, actual users of each service may be evaluated with respect to the corresponding simulation session, such that the analytics data 630 and/or the metric data 632 generated reflects the users of the corresponding streaming service provider application. In some cases, the analytics instructions 616 may include one or more machine learned models and/or networks to determine the analytics data 630 and/or the metric data 632. In these cases, the one or more machine learned models and/or networks may be trained using historical the analytics data 630 and/or the metric data 632.

The feedback generation instructions 618 may be configured to generate and/or organize the feedback data 628 for the third party system based at least in part on user data received from the user during or after a simulation session. In some cases, the feedback generation instructions 618 may utilize the generated analytics data 630 and/or metric data 632 to determine recommendations or additional feedback data 628 for the third party system. In some cases, the feedback generation instructions 618 may include one or more machine learned models and/or networks to determine the recommendations. In these cases, the one or more machine learned models and/or networks may be trained using historical the analytics data 630, the metric data 632, and user feedback data 628.

The reporting instructions 620 may be configured to report the feedback data 628, the analytics data 630, the metric data 632, and the like to the client (e.g., the third party system). In some cases, the reports may include transcripts of any audio provided by the user as well as any trends, recommendations, or the like generated by the platform 104 with respect to one or more simulation sessions associated with a third parties content data 648 and/or service data 624.

The test user selection instructions 622 may be configured to select test users, such as the user, for participation in one or more test simulations. For example, the test user selection instructions 622 may select the user based at least in part on the service data 624, the content data 648, as well as any user data 638 known about each test user. For example, the test user selection instructions 622 may utilize demographic information, such as race, sex, gender, address, education, income, content taste profiles (e.g., based on for instance preferred genres, prior ratings, title consumption history, or the like), consumption hours (e.g., hours per day, week, or month consuming streaming services), job description, and the like. In some cases, the test user selection instructions 622 may include one or more machine learned models and/or networks to determine the recommendations.

The channel management instructions 640 may include a third-party client interface together with or independent from the authoring instructions 642. For example, the channel management instructions 640 may allow each client to customize one or more channels with content data 648 and select users that may be invited to or otherwise access the content data 648 associated with each channel. For example, the third-party client may customize the arrangement of the display (e.g., multiple display portions, paring of advertisement content with title content, selecting from multiple versions of the same content data, or the like).

In some cases, the channel management instructions 640 may allow the third party client to select users to consume the content data 648 via an invitation to one or more particular channels. In other cases, the channel management instructions 640 may allow the third party client to utilize the test subject monitoring instructions 622 to select users for invitation to a particular channel. For instance, the third party client may configure a first channel for conservative viewers and a second channel for liberal viewers and the test user selection instructions 622 may utilize demographic information, such as race, sex, gender, address, education, income, content taste profiles (e.g., based on for instance preferred genres, prior ratings, title consumption history, or the like), consumption hours (e.g., hours per day, week, or month consuming streaming services), job description, and the like to select appropriate users for each of the channels as indicated by the third party client.

The authoring instructions 642 may allow the third party client to author and/or customize the content data 648. For example, the authoring instructions 642 may provide video editing tools that are automated (e.g., machine learned, preprogrammed, or the like) to add effects, features, lighting, snipping, color matching, and the like with respect to the content data 648. The authoring instructions 642 may also provide tools for the third party client to arrange content data 648, such as advertisement placement, product placement within the content, adjusting time of day, weather, setting, (e.g., country v. city), style, (e.g., cartoon graphical styles), and the like. For instance, the authoring instructions 642 tools may allow a client to replace similar products, such as a first soda drink associated with a first retailer with a second soda drink associated with a competitor retailer.

In some cases, the authoring instructions 642 may also allow the third party client to generate insert and/or arrange instructions, prompts, questions (such as related to the survey instructions 646), promos, or the like for the user on the display of the user device. The authoring instructions 642 may also allow the third party client to apply randomization, sequences, intervals, triggers (e.g., time based, content based, user information based, user response data based, or the like) to a channel or content data 648. For example, if a user is providing sensor data 626 and/or feedback data 628 that indicates a response or reception greater than or equal to one or more thresholds, the platform 104 may cause a particular prompt or question to be presented to that user. In this manner, the authoring instructions 642 may allow the third party client to customize an experience of a channel based on substantially real time feedback to improve the overall data collection during the session or consumption event.

The security management instructions 644 may allow for the third party client to adjust the security or accessibility of a channel or other content data 106 by the users of the platform 104. For example, the security management system 146 may allow the third party client to set permissions, passwords, encryption protocols, and the like. The security management instructions 644 may also allow the third party client to generated access codes that may be applied to the content data 648, the channels, and/or provided to users to allow access to particular content data 648 and/or channels. In some cases, the security management instructions 644 may allow for the use of biometric data capture or authentication, such that the platform 104 as well as the third party client may verify the identity of the user prior to allowing access to the particular content data 648 and/or channel.

In this manner, the channel management instructions 640, the authorizing instructions 642, and/or the security management instructions 644 allows the third party client to manage and/or control the content experience encountered by each individual user that is selected to or authorized to consume the content data 648 and/or access a channel.

The survey instructions 646 may be configured to prompt or otherwise present questions (such as open ended, multiple choice, true/false, positive/negative, and the like) either prior to, during, or after consumption of the content data 648. The responses may be provided back to the platform 104 as part of the feedback data 628. In some cases, the survey instructions 646 may cause the presentation of the content data 648 to pause or suspend while the survey questions are displayed to the user. In some cases, the survey instructions 646 may cause a desired position of the content data 648 to replay or recycle while the survey questions are displayed (such as when the questions are presented after the content data 648 is fully consumed). In yet other cases, the survey instructions 646 may cause the presentation of the content data 106 in additional arrangements (e.g., concurrent multiple screens or displays, changes in order or chronology of the output of the content data 648, paring of temporally disparate portions of the content data 648, highlighting, adding icons or indicator, or otherwise altering the original content data 648, such as during a playback, or the like). In this manner, the platform 104 may present alternative endings, alternative advertisements, alternative product placements, alterative styles, alternative character features (e.g., hair color, posture, attitude, stance, clothing, and the like) and receive feedback data 628 from the user on each during a single session.

The third party dashboard instructions 650 may be configured to present the feedback data 628, the analytics data 630, the metric data 632 as well as user data 638 to the third party client, such as via a webhosted application, a downloadable application, or the like. For instance, the third party dashboard instructions 650 may present the feedback data 628, the analytics data 630, the metric data 632 as well as user data 538 to the third party client in a manner that is easy to consume and/or highlights themes, trends, maximums/minimums, peaks/valleys, or other statistical metrics, measurements, displays, graphs, or the like.

The live channel event instructions 652 may be configured to allow multiple users to view live content data (such as sporting events, live broadcasts, live streams, live social media events, debates, and the like). In the live channel event, the live channel event instructions 652 may allow the platform 104 to receive user interaction data, feedback data, and/or sensor data form multiple users to rate reactions, emotions, feelings, and the like in substantially real-time as the event happens. In this manner, the platform 104 may provide, such as via the third party dashboard instructions 650, substantially real-time or concurrent reporting data and metrics to the third party clients as the live event occurs. In some cases, the live channel event instructions 652 may allow for audio communication between users consuming the content data of the live event. In some cases, the live channel event instructions 652 may cause the platform 104 to generate a transcript of the audio data and/or the audio communications of the multiple users.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A platform comprising:
one or more communication interfaces to communicate with a user device;
one or more processors; and
computer-readable storage media storing computer-executable instructions, which when executed by the one or more processors cause the one or more processors to:
receive content data from a third party system, the content data associated with one or more of a title or advertisement for consumption by a user via a streaming service;
generating, based at least in part on service data, a simulated user interface associated with a streaming service;
selecting a first user to evaluate the content data from a plurality of test users;
receiving interaction data and sensor data associated with the first user from a first user device associated with the first user, the interaction data and the sensor data captured while the first user consumed the content data via the simulated user interface on the first user device;
determining, based at least in part on the interaction data and the sensor data, at least one metric associated with the content data; and
sending the at least one metric to the third party system.

2. The system as recited in claim 1, wherein the computer-readable storage media stores additional computer-executable instructions, which when executed by the one or more processors cause the one or more processors to:
selecting the streaming service from a plurality of streaming services based at least in part on the content data or request data provided by the third party system.

3. The system as recited in claim 1, wherein the service data is received from the third party system with the content data.

4. The system as recited in claim 3, wherein generating the simulated user interface associated with the streaming service further comprises inputting the service data into one or more machine learned models and receiving as an output of the one or more machine learned models the simulated user interface.

5. The system as recited in claim 1, wherein the interaction data is first interaction data, the sensor data is first sensor data, and the computer-readable storage media stores additional computer-executable instructions, which when executed by the one or more processors cause the one or more processors to:
selecting a second user to evaluate the content data from the plurality of test users, the second user different than the first user;
receiving second interaction data and second sensor data associated with the second user from a second user device associated with the second user, the second interaction data and the second sensor data captured while the second user consumed the content data via the simulated user interface on the second user device; and
wherein determining the at least one metric associated with the content data is based at least in part on the second interaction data and the second sensor data.

6. The system as recited in claim 1, wherein the simulated user interface includes a first portion of the simulated user interface associated with the platform and a second portion of the simulated user interface simulating the user interface associated with the streaming service.

7. The system as recited in claim 1, wherein determining the at least one metric associated with the content data further comprises:
generating, based at least in part on the interaction data and the sensor data with additional interaction data and additional sensor data associated with other users that consumed the content data via the simulated user interface, aggregated data; and
determining, based at least in part on the aggregated data, at least one trend associated with the content data.

8. The system as recited in claim 1, wherein the content data includes at least one title consumable by the first user via the simulated user interface.

9. The system as recited in claim 1, wherein the content data includes at least one advertisement consumable by the first user via the simulated user interface.

10. The system as recited in claim 1, wherein the content data includes an advertisement and at least one title, the advertisement to be consumed together with the at least one title the first user via the simulated user interface.

11. A method comprising:
receiving content data and service data from a third party system, the content data associated with one or more of a title or advertisement for consumption by a user via a streaming service;
generating, based at least in part on the service data, a simulated user interface associated with a streaming service;
selecting a first user to evaluate the simulated user interface from a plurality of test users;
receiving first interaction data and first sensor data associated with the first user from a first user device associated with the first user, the first interaction data and the first sensor data captured while the user consumed the content data via the simulated user interface on the first user device;
determining, based at least in part on the interaction data and the sensor data, at least one metric associated with the service data; and
sending the at least one metric to the third party system.

12. The method as recited in claim 11, further comprising:
selecting the streaming service from a plurality of streaming services based at least in part on the content data or request data provided by the third party system.

13. The method as recited in claim 12, further comprising:
selecting a second streaming service from the plurality of streaming services based at least in part on the content data or request data provided by the third party system;
generating, based at least in part on the service data and the second streaming service, a second simulated user interface associated with the second streaming service;
receiving second interaction data and second sensor data associated with the first user from a user device, the second interaction data and the second sensor data captured while the first user consumed the content data via the second simulated user interface on the first user device; and
wherein determining the at least one metric associated with the service data is based at least in part on the second interaction data and the second sensor data.

14. The method as recited in claim 11, wherein the content data includes at least one title consumable by the first user via the simulated user interface.

15. The method as recited in claim 11, wherein the content data includes at least one advertisement consumable by the first user via the simulated user interface.

16. The method as recited in claim 11, wherein the content data includes an advertisement and at least one title, the advertisement to be consumed together with the at least one title the first user via the simulated user interface.

17. One or more non-transitory computer-readable media having computer-executable instructions that, when executed by one or more processors, cause the one or more processors to perform operations comprising:
receiving content data from a third party system, the content data associated with one or more of a title or advertisement for consumption by a user via a streaming service;
generating, based at least in part on service data, a simulated user interface associated with a streaming service;
selecting a first user to evaluate the content data from a plurality of test users;
receiving first interaction data and first sensor data associated with the first user from a user device associated with the first user, the interaction data and the first sensor data captured while the first user consumed the content data via the simulated user interface on the first user device;
determining, based at least in part on the first interaction data and the first sensor data, at least one metric associated with the content data; and
sending the at least one metric to the third party system.

18. The one or more computer-readable media as recited in claim 17, wherein selecting the streaming service from a plurality of streaming services based at least in part on the content data or request data provided by the third party system.

19. The one or more computer-readable media as recited in claim 17, having computer-executable instructions that, when executed by the one or more processors, cause the one or more processors to perform operations comprising:
generating, based at least in part on the first interaction data and the first sensor data with additional interaction data and additional sensor data associated with other users that consumed the content data via the simulated user interface, aggregated data; and
determining, based at least in part on the aggregated data, at least one trend associated with the content data.

20. The one or more computer-readable media as recited in claim 17, having computer-executable instructions that, when executed by the one or more processors, cause the one or more processors to perform operations comprising:
selecting a second user to evaluate the content data from the plurality of test users, the second user different than the first user;
receiving second interaction data and second sensor data associated with the second user from a second user device associated with the second user, the second interaction data and the second sensor data captured while the second user consumed the content data via the simulated user interface on the second user device; and
wherein determining the at least one metric associated with the content data is based at least in part on the second interaction data and the second sensor data.
